(19) United States
(12) Patent Application Publication
(10) Pub. No.: US 2010/0181773 A1
(43) Pub. Date: Jul. 22, 2010

(54) Flow utilisation multiplier

(76) Inventor: Walter Reist, Hinwil (CH)

Correspondence Address: Oppedahl Patent Law Firm LLC - Frei, P O Box 5940, Dillon, CO, 80435-5940, US

(21) Appl. No.: 12/411,469

(22) Filed: Mar. 26, 2009

(30) Foreign Application Priority Data
Jan. 16, 2009 (CH) 00073/09
Mar. 19, 2009 (CH) 00418/09

(51) Int. Cl. F03B 13/00

(52) U.S. Cl. 290/54

(57) ABSTRACT

A device for producing electricity from flowing water, with a plurality of onflow elements arranged in an essentially chain-like manner, of which plurality, a number forms a load section when immersed into the flowing medium, and another number of the same plurality, then running above the water surface, forms a return section or empty section, and are led forwards and backwards via deflection elements, wherein work may be taken at at least one deflection element.

The invention lies in the field of electricity production with the help of flowing water, and relates to a device with which one may produce work and electricity in any type of flowing water.

A multitude of devices are known, which are capable of converting the kinetic energy of flowing water into work, for example the undershot mill wheel. Thereby, movable means are subjected to a flow in a controlled manner, by way of which they are subjected to onflow and moved away. The dislocations are converted into a rotational movement and are taken from the shaft of the mill wheel as work. This is the general principle of practically all these devices. With the undershot mill-wheel-like device, a blade immerses into the flow, is carried along and re-emerges, whilst a further blade arranged on the wheel submerges and is pulled along by the flow. Thus, one to two blades are continually in the flow, and the others are outside it. Each immersed blade makes a contribution to the production of energy. With 50 blades on a wheel, two blades make a contribution, which mathematically makes up 4%. Then, as to whether such a mill wheel has 50 or another number of blades and whether two or three blades immerse simultaneously, is not significant in this example. It is merely simply shown that only a relatively small share of “energy conversion elements” is simultaneously active.

This excludes all devices with which a type of screw or propeller converts the kinetic flow energy directly into a rotation, at whose shafts work may be taken.

It is the object of the invention to improve this ratio, or more specifically, to significantly improve this ratio. The solution of this is defined in the patent claims, and is explained and described subsequently with the help of drawings.

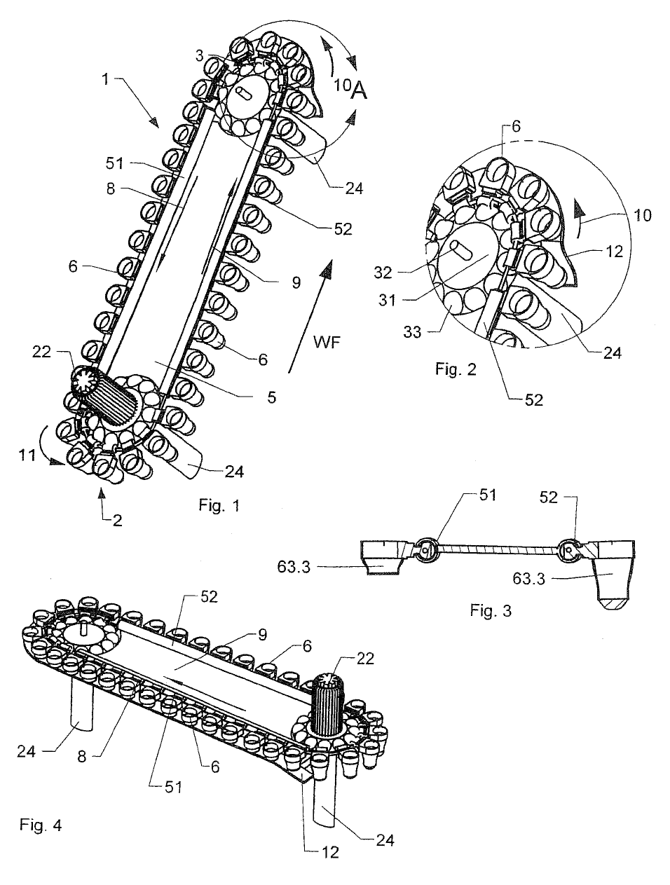

FIGS. 1 to 4 show a first embodiment of a device according to the invention

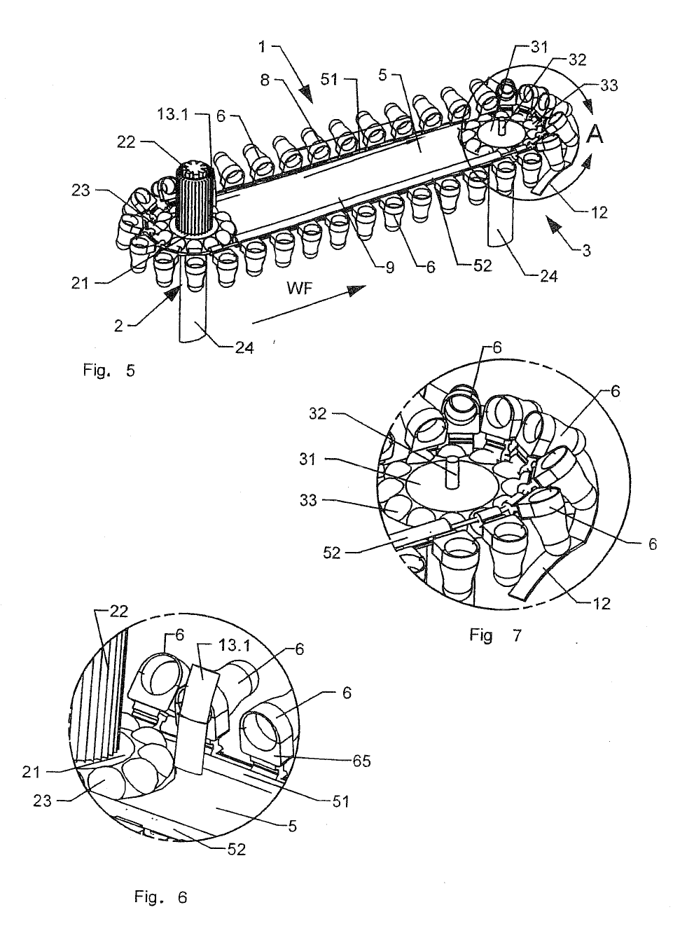

FIGS. 5 to 7 show a second embodiment of a device according to the invention.

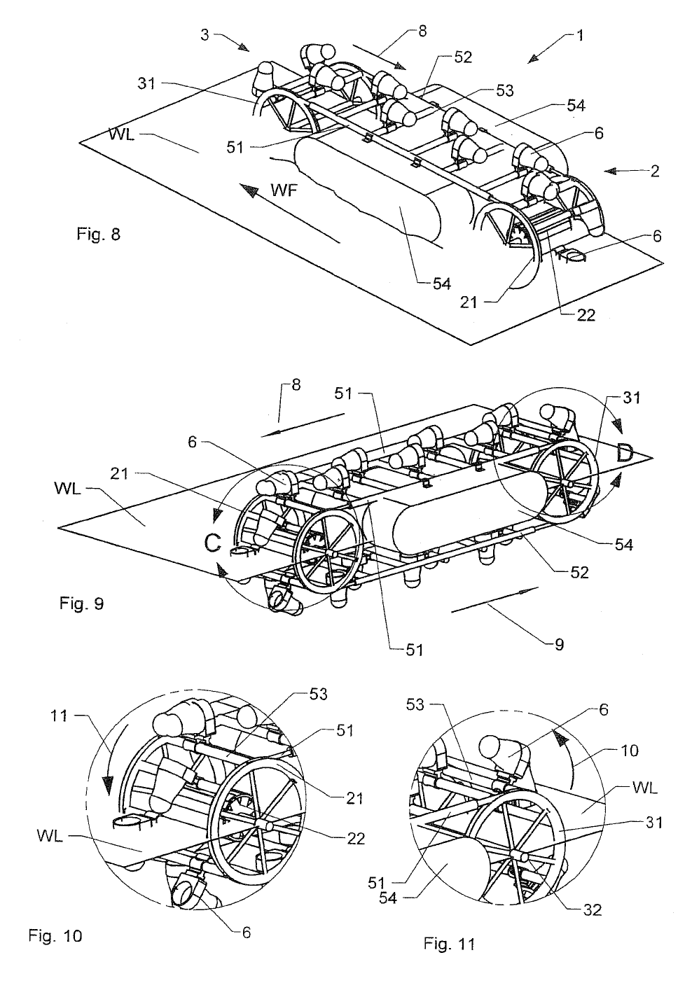

FIGS. 8 to 11 show a third embodiment of a device according to the invention.

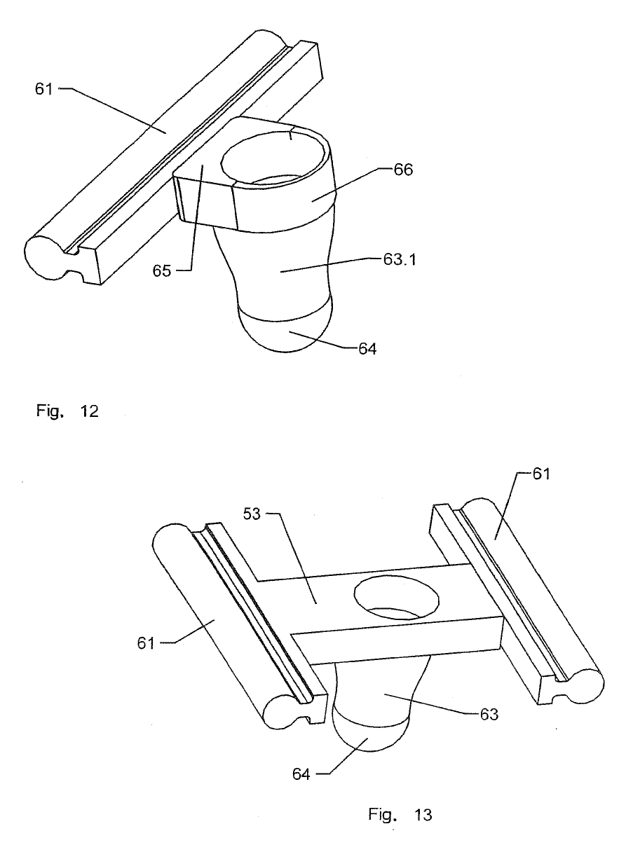

FIGS. 12 and 13 show preferred embodiments of a sliding holder on onflow elements, with which no pull elements are required.

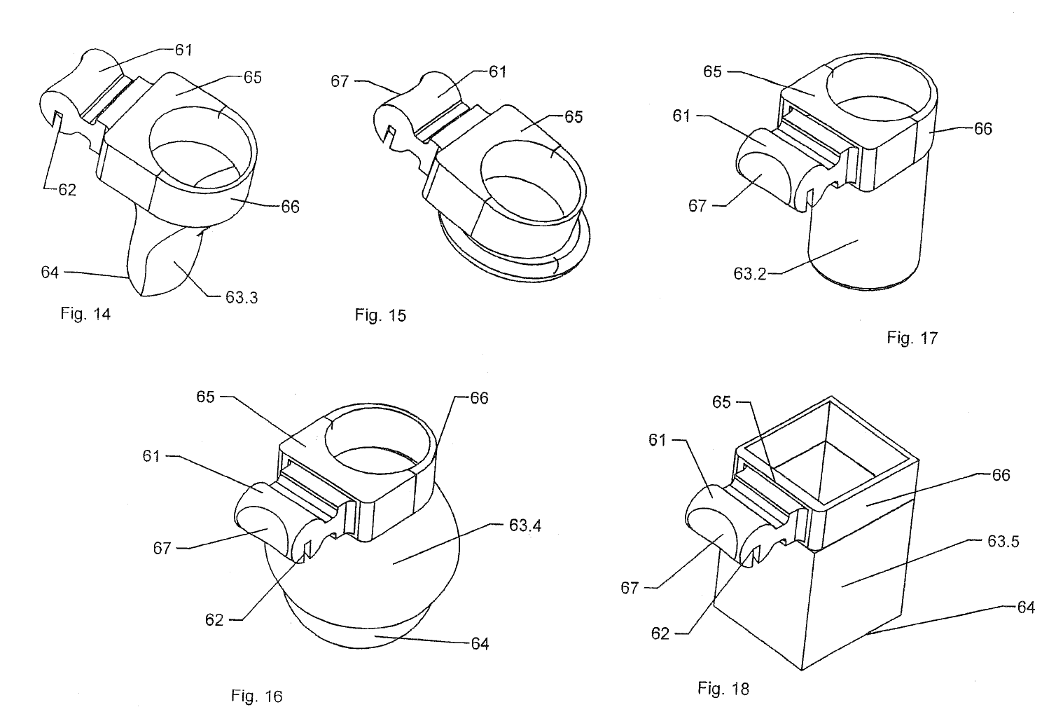

FIGS. 14 to 18 show examples of different possible onflow elements.

FIGS. 19 and 20 show a further embodiment with containers which mutually close one another and are rowed together into a unit in the load section.

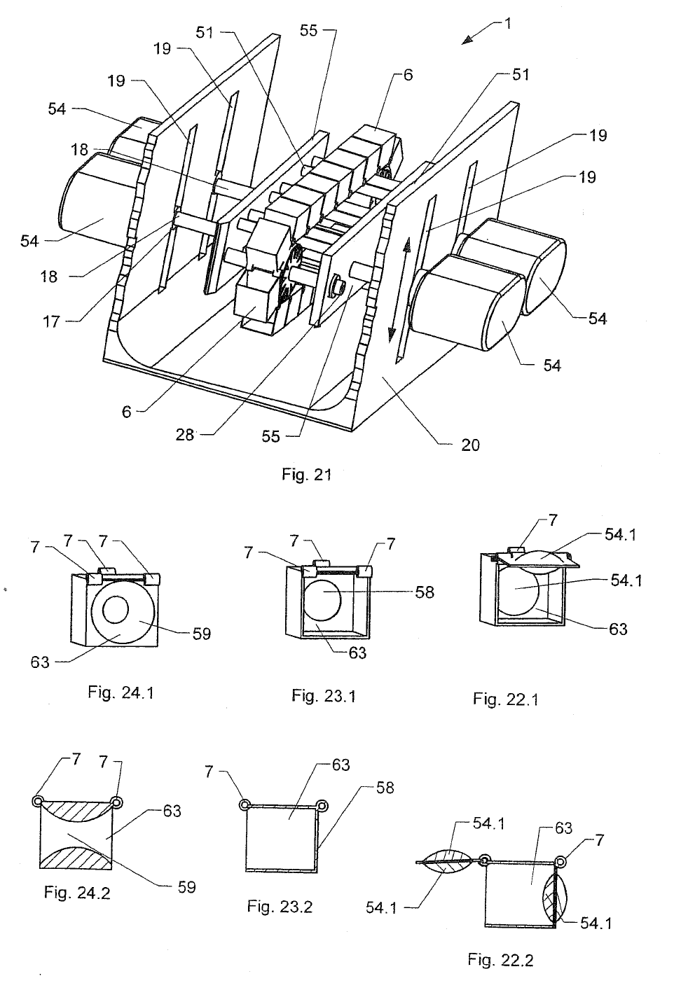

FIG. 21 shows the embodiment of FIG. 19 applied in a channel, and the FIGS. 22.1 to 24.2 show different container shapes for this embodiment.

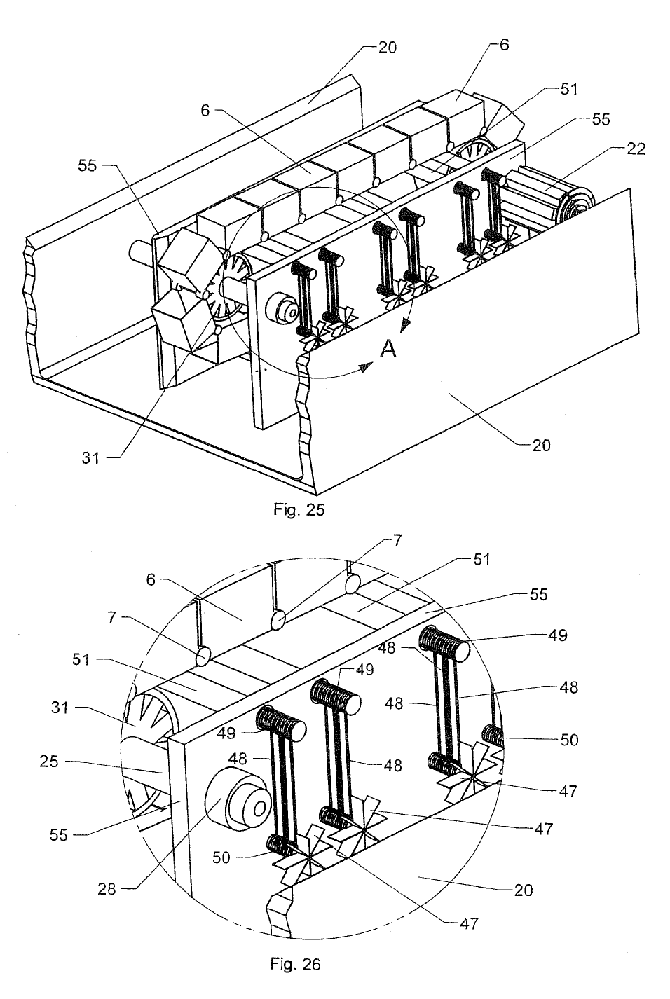

FIGS. 25 and 26 show a support for the return section, in order with this, to relieve the load section.

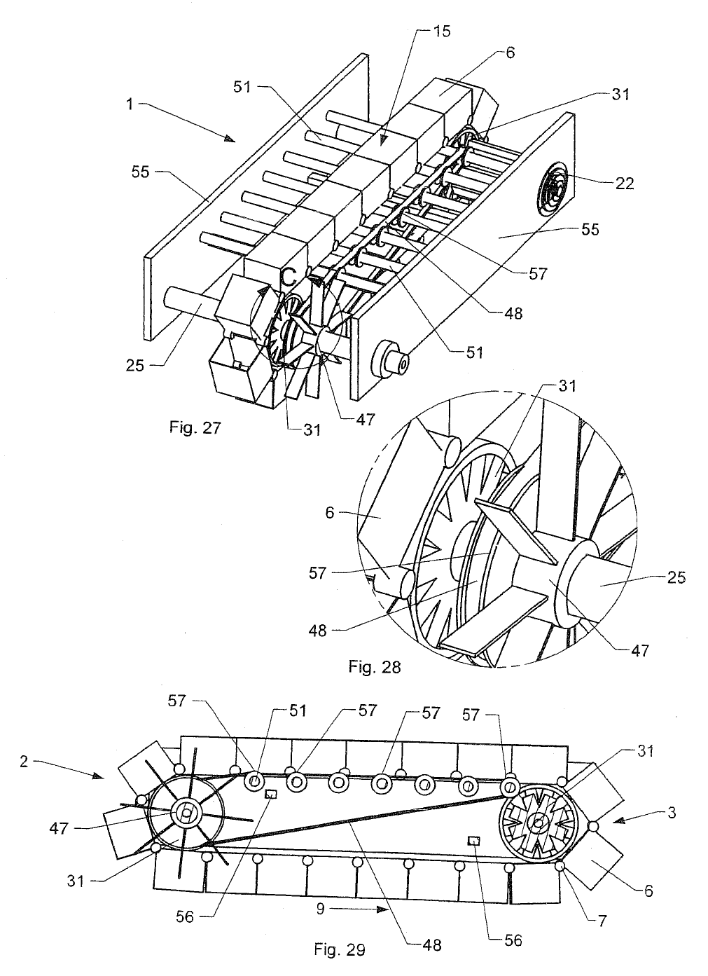

FIGS. 27, 28 and 29 show a further support for the return section, in order with this to relieve the load section.

FIG. 31 shows a variant of a container which may be joined together into a chain and may be folded out and collapsed, for reducing the submerged buoyancy.

FIG. 1 shows a first device 1 with a multitude of onflow elements 6, which are guided along on a guide 51 and 52. The guide 51 is the guide for the load section, and the guide 52 is the guide for the return section or empty section. The two guides 51 and 52 are attached on a platform 5. The onflow elements 6 revolve around a first and a second deflection 2 and 3, an immersion deflection rotor 2 and an emptying deflection rotor 3. The onflow elements 6 are designed in a vessel-like manner, thus they may receive a load, in these examples it is water, and release this load again or discharge water again. The onflow elements 6 of the load section are at least partly immersed into a flow, which here is represented by an arrow WF and simultaneously shows the flow direction. The device is fixed on the ground with supports 24. A further embodiments is shown, with which no supports are necessary, but floats hold the device in the flow. The reference numerals 8 and 9 show the running directions of the emptying section and load section, and reference numerals 10 and 11 show the emptying region and the immersion region.

FIGS. 2 and 4 show the two deflections, here indicated in more detail as a generator wheel 21 with a generator 22 for electricity production, which is attached onto the generator shaft 25, and with a generator wheel toothing 23 for engaging onto the onflow elements 6, and in contrast, as an emptying wheel 31 with an emptying wheel toothings 33 and with an emptying wheel shaft 32, onto which a generator may of course also be applied. The onflow elements 6 which are coherent in a chain-like manner, thus revolve around the two deflections, once as a load section, arrow 9, and once as an empty section, arrow 8. Whereas the onflow elements 6 of the load section are immersed into the flow, the onflow elements 6 in the empty section are above the water surface.

In the empty section according to FIG. 4, one recognises that the onflow elements 6 which are located in this device section have a different shape than in the load section according to FIG. 1. This is because the onflow elements 6 in this example, as is shown in FIG. 3 in section, are flexible, bag-like elements which, when they are pressed up by the emptying guide 12, empty to a large extent, and thus need to overcome a lower potential energy/potential work (against gravity). It would not make sense to lift the completely full container upright above the water surface, in order to guide them back as an empty section in a filled manner. The emptying is effected, as specified, via the emptying guide 12, visible in FIG. 2, and the refilling is effected via a filling guide 13, visible in FIG. 4. The complete empty section with the containers which are essentially empty here, may be recognised in FIG. 4.

Now to the functioning of the device. The immersed onflow elements in the load section are subjected to flow by the flow in the direction W1 and are driven away and this, in this example, is about fourteen fold. Thus almost half, well over 40% of the onflow elements are simultaneously active, which entails a significantly improved utilisation of the present kinetic energy than with the undershot mill wheel described above. The essentially emptied onflow elements in the emptying section reduces the drive share by the lifting work on emptying, and reduces any occurring sliding resistance in the empty section, and finally also the friction energy of the complete device. The distances of the onflow elements to one another should be so large that the front onflow surface comes to lie outside the turbulence zone of an onflow element which is at the front with regard to the flow, said turbulence being produced at the rear side. Details and examples as to how the onflow elements may be designed, and as roughly as to which flow characteristics they have, are discussed in the detailed figures further below.

FIGS. 5 to 7 now show a further embodiment of a device according to the invention. Here at first glance, one may recognise that the onflow elements are emptied out for forming the empty section.

FIG. 5 shows a second device 1 with a multitude of onflow elements 6, which run along a guide 51 and 52. The guide 51 is the guide for the load section, and the guide 52 is the guide for the empty section. The two guides 51 and 52 are also attached on a platform 5. The onflow elements 6 revolve around a first and a second deflection 2 and 3, an immersion deflection rotor 2 and an emptying deflection rotor 3. The onflow elements 6 in this example are designed in a rigid, vessel-like manner, in order to receive a load are immersed, and are tilted in order to discharge a load. The onflow elements 6 in the load section are immersed into the flow, which here flows in the direction of the arrow WF. The device is fixed on the ground with the supports 24. The two deflections are also designed as a generator wheel 21 with a generator 22 for electricity production, which is applied on the generator shaft 25, with a generator wheel toothing 23 for the engagement onto the onflow elements 6, and as an emptying wheel 23 with an emptying wheel shaft 32, with an emptying wheel toothing 33. The onflow elements 6 which are coherent in a chain-like manner, revolve around the two deflections, once as a load section, direction of arrow 9, and once as an empty section, direction arrow 8. Whereas the onflow elements 6 of the load section are immersed into the flow, the onflow elements 6 in the empty section are likewise above the water surface, but in the tilted position. As with the first embodiment, one must therefore accomplish a lower potential energy/potential work (against gravity). The emptying is effected via an emptying guide 12, well visible in FIG. 7. The flow elements 6 must be tilted back again for refilling. This is effected via a web or restoring beams 13.1, past which the onflow elements 6 move, and are brought from their tilted position into the filling position, this is well visible in FIG. 6. The complete empty section with the containers which are now completely emptied here, may be recognised in FIG. 5.

The FIGS. 8 to 11 show a third embodiment of a device according to the invention. Here one recognises that the onflow elements are discharged upside down at the empty section.

FIG. 8 shows a device 1 with a multitude of onflow elements 6 which run along between the guides 51 and 52. The complete device is shown immersed into a water surface WL. The fastening of the onflow elements 6 on both sides of the guides 51 and 52 prevents the torque which acts on the fastening elements with the first embodiments and thus creates a slight canting of these in the guide. The reference numerals 51 and 52 have been retained, but are no longer called empty section and load section, but the guides. The load section is under water, the empty section is above water. With this embodiment, one has the possibility of selecting the fastening means for the onflow elements 6, here a retainer web 53 for fastening the onflow elements, so large, that the onflow elements 6 may be arranged offset in the flow direction, so that each onflow element 6 may be subjected to onflow in a practically undisturbed manner. In FIG. 8, one may recognise in each case half of the immersion deflection rotor 2 and of the emptying deflection rotor 3 above the water surface WL. Furthermore, one recognises the empty section 8 which runs in the direction of the arrow between the guides 51 and 52. These guides 51 and 52 are in each case fastened on two float bodies 54. The deflection for surfacing, or the emptying wheel 31, has the same function as with the two previously discussed embodiments. One or the generator 22 is arranged on the opposite side, in the deflection for immersing the onflow elements 6, on the generator wheel 21. All these figures have a schematic character, so that components which are not absolutely necessary have been omitted, and here, these are the for example electrical connections of the generator, as this has been this kept to in the previously discussed figures. The device here has an anchoring which is not shown, which has the effect that the complete device does not float away and that above all it does not form a resistance to the flow.

FIG. 9 apart from the above-water view, yet shows a part of the device, which is below water, above all the load section 9 with the onflow elements, which are driven by the flow. The water surface WL is reduced to such a level that one may easily see the immersed device parts. FIG. 9 shows two cut-outs C and D at the two deflections for the immersion and surfacing, which are shown in a detailed manner in the FIGS. 10 and 11. Thus in FIG. 10, one recognises the generator 22 or its rotor, which is arranged on the shaft in the deflection wheel 21, and the stator housing of this is fixed (not shown) on the emptying wheel shaft 32 of the emptying wheel 31 in FIG. 11, and thus is prevented from co-rotating with the generator rotor. The onflow elements 6 have a somewhat greater efficiency that those onflow elements 6 arranged in a row behind one another due to the offset onflow elements 6 which are thus exposed to the unhindered flow.

There a still a few possibilities of optimising the embodiments according to the invention in this manner.

FIGS. 12 and 13 show a preferred embodiment of the onflow elements 6. An onflow element has different tasks to fulfil, it should be able to be fastened individually or be able to be applied into the guides individually, it should be exchangeable, it should be stable in its guiding and it should be easily guidable and it should also have an as large as possible flow resistance. Thus FIG. 12 shows an onflow element 6 in the form of a container 63.1 with a base zone 64, a stiffening 65 which on the one side comprises a container ring 66 arranged thereon, and on the other side a fastening part 61 which is cylinder-shaped here. The cylinder-shaped fastening part 61 has a length which determines the distances of the containers to one another. These onflow elements are inserted individually into the guides 51, 52 without connecting them to one another, so that they abut in a contacting manner in the desired direction. Thereby, the guides must also be led over the deflections, which is not shown in detail here. The advantage of this embodiment is the fact that the fastening parts stabilise under load thus when they are abutted, and the action of the unavoidable torque of the container subjected to the flow, via the fastening parts onto the guide, is partly absorbed. The total length is selected such that the containers arranged in a row may be adequately subjected to the flow.

FIG. 13 shows an embodiment corresponding to FIG. 12, with two cylinder-shaped fastening parts 61 which are connected via a container web 53, and, suitably adapted may, be used in combination with the third embodiment of the device according to FIG. 8. In this embodiment, the problem of the “unavoidable torque” is practically done away with.

The two FIGS. 14 and 15 show an embodiment of an onflow element 6, as is shown in the first embodiment of the device according to the FIGS. 1 to 4, specifically those which are pressed out from the bottom for emptying. In the container region 64, it has the shape of a “sack” 63.3, which in FIG. 14 is represented filled and in FIG. 15 is represented emptied. In FIG. 15, one recognises how the bag-like container 63.3 is pressed together into a bead. The bag-like container region 63.3 is fastened on the stiffening by way of a container ring 66. The fastening part 61 which is arranged on the stiffening 65, as from the previously discussed embodiments of the onflow elements 6, are fastenable on the pull element of the revolving entity with a positive or non-positive fit by way of pull connection notches 62. The container region 63.3 of the onflow element 6 is pressed up by way of moving to the emptying guide 12 and is thus emptied and is conveyed in this pressed-up position along the empty section 8 back to the immersion and deflection rotor 2, in order then, via the filling guide, which brings it back to the bag shape, to immerse again into the flow, in order to be filled up.

The pull connection notch 62 for suspension in a pull cable of the revolving entity or for fastening onto this, is advantageously designed with a positive fit in order to avoid a possible hanging-out or slipping out at the deflections, where the fastening part 61 leaves the guides. This is simply as an additional safeguard. For this, one forms two swallow-tail-like notches, for example on the fastening part 61, into which longer or shorter pull cable sections may be locked in each case with the swallow-tail counter-piece, between the containers. With this, the distance between two onflow elements 6 is fixed (similarly as with the embodiments according to FIGS. 12 and 13), and the elements may not dislocate. One assumes that each container is affected by the flow, such that it either pulls the container along upstream or brakes the container downstream, and thus maintains the distance to the containers at the front and rear in the row.

FIG. 16 shows another form of the onflow element 6, in which the container region has a ball-like part 63.4 and the base zone 64 is shaped somewhat smaller in a spherical manner. The container region 63.4 may be designed in a rigid or soft form. Given an onflow, the pressure resistance of this ball-like body is approx 90% and has a friction resistance of approx. 10%.

FIG. 17 shows a further onflow element 6, whose container shape is formed in a cylindrical manner 63.2, and the base zone 64 is formed in a flat manner. Given an onflow, the pressure resistance of this round body is also approx. 90% and the friction resistance approx. 10%.

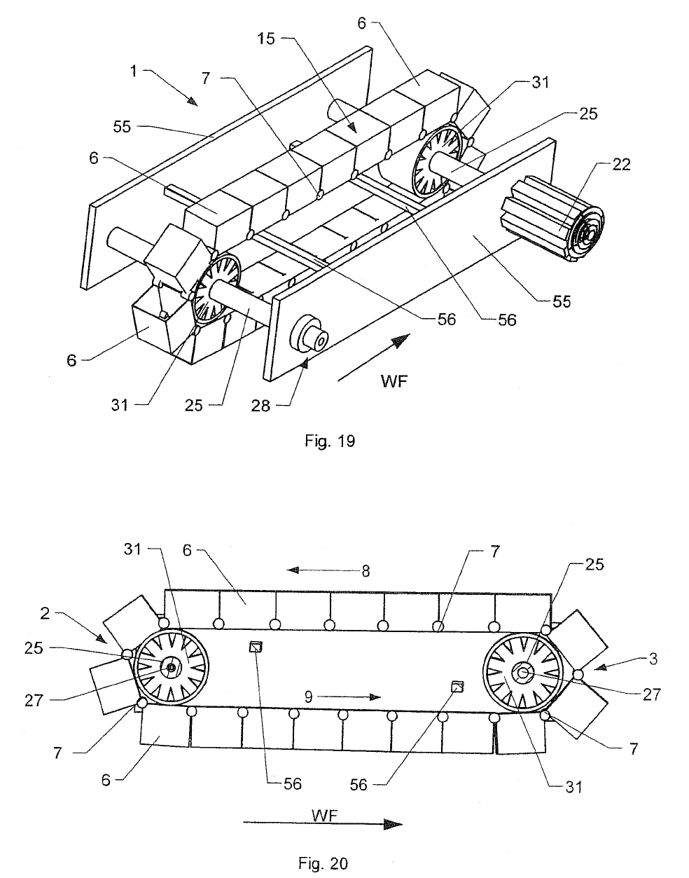

FIG. 18 shows a further embodiment of an onflow element 6, with which the container region is formed in a cubic manner 63.5. This flat onflow surface of the container region 63.5 practically has a pressure resistance of approximately 100%.

The percentage values were all taken from a general flow table and are to be taken as being approximate. All these forms have different onflow and resistance characteristics, wherein yet further shapes and forms are also possible, and this may be determined by way of testing and optimisation.

FIG. 19 as a principle representation, shows a further embodiment of the invention, specifically an arrangement of the containers similar to the embodiment according to FIGS. 8 to 11, where the container is emptied upside down. In the further developed embodiment, the containers themselves form a chain. They are directly connected to one another via a rotatable, hinge-like connection. The device 1 consists essentially of two holding plates 55, between which a deflection wheel 31 is arranged in each case on a shaft 25. The container chain 15 with the containers 6 is guided over the two deflection wheels 31. The container 6 are connected in a pullable, pushable and rotatable manner via connection elements 7. Two connection struts 56 ensure an additional stability. An arrow WF in the two figures show an imagined water flow. On the side of the emptying, a generator 22 which with its housing is fixed for example on to the holding plates 55, is applied on the shaft 25. The container chain 15 is “stiff” in the empty section, and in the load section it is likewise fixed in an essentially linear manner by way of intended buoyancy. More about this further below. This device is a basic embodiment which is functionally expanded by way of further measures.

FIG. 20 shows the device 1 in the longitudinal section. One recognises how the shafts 25 with the drive wheels 31 rotate on an axis 27, which is fastened between the holding plates. FIG. 19 schematically shows a lubrication location 28 for the lubrication between the axle and shaft. The two connection struts 56 are arranged above and below an imagined line between the two shafts 25, in order thus to form a stable 4-point strutting. The two arrows 8 and 9 show the running direction of the load section and the empty section and thus the filling locations and emptying locations on the device. With the further two arrows, the immersion deflection rotor is indicated at 2 and the emptying deflection rotor is indicated at 3.

The difference to the previously discussed embodiments lies essentially in the reduced distance of the containers to one another. In this example, they are joined together into a conveyor chain and mutually close after the immersion and partial filling, and the base of the one serves as a lid for the other. The degree of filling is directed the water level or the immersion depth of the load section. Depending on the mutual sealing of the containers and the selected partial filling, a buoyancy rises by way of the displacement in the medium, here in the water, by which means a “floating” load section arises. The inventor describes it metaphorically as a “floating tree trunk” (which is formed and is abrogated again) and its energy content. With this, the load section which on the one hand is subjected to flow at the immersing containers and on the other hand along the walls and is thus moved, has a greater weight and thus a greater inertia, which leads to a more uniform running of the device for obtaining energy. The fluctuations by way of the change in the onflow are now lower due to the inertia of the system. Of course, with this, the starting up of the device for taking up energy is more lethargic and also the braking of the device for example by way of the generator, requires more energy than if there were no inertia.

In order to influence and also control the flow conditions, the device according to FIG. 19 is installed into a channel which is shown in FIG. 21. Represented in a schematic manner one recognises a channel 20 of a freely selectable length with means 19, for example guide slots, into which holding devices 54 which are attached on the device in the both sides, here it is four floats, are fixed in a displaceable manner. Either the device is set and fixed with regard to the height, and, if desired, in inclination, with a setting device 17, and this is shown by the double arrows, or the floats 54 automatically set the height according to the water level. As already mentioned above, the degree of filling in the containers is determined by the immersion height and thus, in certain designs, also the buoyancy. The complete installation, the device 1 together with the channel 20, is placed into the flowing medium.

Of course, the device may also be applied into the flowing medium on its own, without the channel, if one wishes to make do without any specific onflow characteristics. Moreover, several of the devices 1 may also be placed next to one another and after one another, in a channel 20 or outside it, in order thus to achieve a redundancy and multiplication of the power (energy generation).

The design of the containers 6 makes a significant contribution, which is shown in the following FIGS. 21.1, 23.1, 24.1 or 22.2, 23.2. 24.2. Firstly, the immersion of the containers should be simplified and specifically, such that the base part of the container 6 experiences as little as possible immersion buoyancy on immersion, and thus brakes the running of the device as little as possible. All three variants are containers which form a chain 15 which is shown by way of the connection elements 7. All three variants have the aim of keeping the buoyancy as low as possible on immersion. For this, it is suggested to incorporate an opening in the container base for simplifying the penetration of the water, which is then closed in the load section. Further flow-technical measures, of which there are probably many, are yet added thereto. Thus the FIGS. 24.1 and 24.2 show a continuous flow narrowing 59 in the container region 63, which goes through the container 6 such that the flow is accelerated in the narrowing and slows down again after the narrowing. The containers 6 which are rowed on one another, in this manner experience a pulsating through-flow with probably a slight formation of eddies. With this embodiment too, one may immerse so far that a buoyancy of the load section arises. One may design the flow narrowing 59 with buoyant material, by which means the container has its own buoyancy.

A further variant is shown in the FIGS. 23.1 and 23.2, in which the container 6 only comprises a container wall opening 58, here for example the container base, for the simplified penetration of water, in order thus to reduce the immersion buoyancy. Eddies form behind this opening and thus form a resistance to the penetrating flow, probably to the extent which would be the case if the container base had no opening and were to be subjected directly to onflow. With this one obtains the effect of the reduced immersion buoyancy and the effect of increased flow resistance.

A further variant is shown in the FIGS. 22.1 and 22.2, with which no container base is provided in the open container, but is designed as a lid with a float 54.1. As soon as the container pivots over the deflection wheel 31 down onto the immersion side, the base lid with the float 54 opens and hangs on the container 6 in an open manner. On immersion, the float in this position immerses first of all and the container base is still open. Successively, the cover with the float begins to close the container base, but then the container is already immersed without producing an immersion buoyancy. On connecting to the preceding container of the load section, it fills with water and is finally closed by the lid of the subsequent container. This variant with each degree of filling has its own certain buoyancy, so that the height of the water line on the device is only important for the degree of filling.

A further embodiment of the device according to the FIGS. 19 and 21 lies in relieving the load section with the help of energy, which one likewise takes from the flowing medium. The empty section per se has its own inertia and it must be led or pulled over the mechanical parts such as rollers or slide surfaces, which reduces the power obtained at the load section. The embodiment according to the FIGS. 25 and 26 improves this by way of driving a few or all of the rotatable empty section guides 51 on which the containers 6 of the empty section rest, or over which they slide, by way of flow energy in the corresponding direction, and thus support the empty section on the way to the immersion location. For this, empty section drive means 50, for example pulleys, are rotatably fastened on a shaft at the selected locations on one of the holding plates 55, on which means an empty section drive wheel 47 is arranged. This drive wheel is a water wheel for example, which does not need to be described extra with regard to its embodiment. Drive belts 4 run from this empty section drive means 50, to the empty section guides 51 which are specially adapted on this side, and drive these in the respective direction. The water wheels immerse by less than hall into the flow and thus drive the empty section guides 51 in a corresponding manner, so that they all lead roll along as well, even of the empty section possibly runs more quickly over the guides and still has a small share of sliding friction.

FIGS. 27 to 29 show a further possibility of relieving the load section. The total view in FIG. 27 shows the construction according to FIG. 19 or 21, with the difference that the empty section drive wheel 47 is arranged on the shaft 25, and that the electricity generator 22 is placed between the holding plates 55 and fixed thereto. One further recognises a drive belt 48 which runs over the empty section guides 51. The empty section guides 51 are rotatably mounted between the holding plates and in each case carry a pulley 57, over which the drive belt 48 runs and drives each empty section guide separately in the correct rotational direction. The cut-out in the region of the empty section drive wheel 47, which is shown in FIG. 28A, shows the course of the drive belt 48 over the pulley 57, in an enlarged manner. FIG. 29 finally shows a longitudinal section through the complete device, in which the whole course of the drive belt 48 from the drive wheel over the pulleys and back, is shown. One may provide a slip coupling between the empty section drive wheel 47 and the shaft 25, by way of which a leading or trailing of the container chain is compensated. The drive for the empty section may of course also be provided on both sides of the device 1.

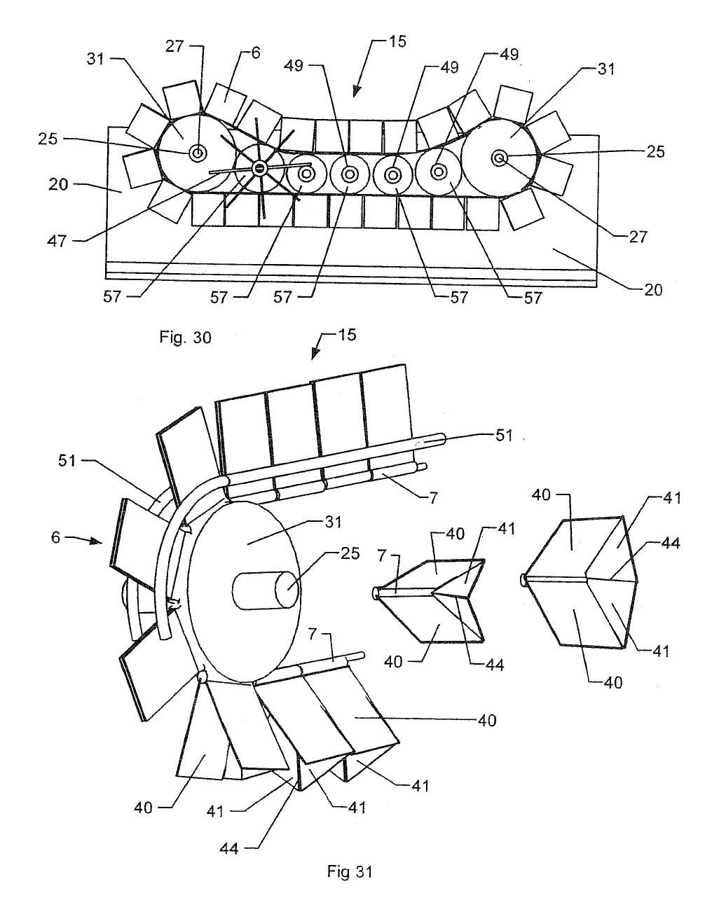

FIG. 30 shows a further possibility of relieving the load section. Schematically in section, one recognises a device which is derived from the basic unit, fastened in a channel 20, of which only the rear wall is to be seen in the projection. The empty section of the container chain 15 runs over an empty section drive for relieving the load section. The connections of the containers in the container chain are of a nature such that they permit an increase and reduction of the distance to one another. The empty section shafts 49, here enlarged, serve as roller bearings for the empty section. An empty section shaft 49 is enlarged with respect to the average in the direction of the filling region, thus to the left in the figure, so that a rise in the container chain 15 arises, and, since this empty section shaft is driven by way of an empty section drive wheel 47, as is already shown in the FIGS. 25 to 29, the respective container chain part is also dragged uphill so to say and thus is driven. Such empty section drives may of course be arranged at several locations on the empty section shafts 49, also to the left as well as the right, for supporting the drive. If one additionally provides a further empty section drive on the empty section shaft 49 on the emptying side, then the empty section is pushed uphill from the emptying side and uphill on the immersion side.

FIG. 31 shows a container chain of a different type, with which the containers have practically no immersion buoyancy, but oppose the flow with a greater resistance, for example as a container chain with closed containers. The containers are grouped via a hinge-like connection means 7 into a chain and run folded together in the empty section, and are opened on immersion into the medium and thereby are filled into a load section in the flowing medium. The distance between the foldable containers may be selected in an infinite manner. In FIG. 31, one recognises a piece of the container chain before immersion, on the immersion side of the device. The container chain 15 runs between two empty section guides 51, which maintain the containers in the collapsed condition. The containers is still closed in phase 1, and the container begins to fold out in phase 2, and is open and may be filled in phase 3. This variant of the containers joins into the empty section in a closed manner. Two containers are drawn separately for an improved illustration, one in the semi-opened condition and the other in the opened condition.

The container consists of two plates 40 which are hinged by way of a connection means 7 and which are connected to side flaps 41 which are capable of a folding movement in a hinge-like manner and which for their part are connected via a fold 44. The container is closed, or partly to completely opened, depending on the position of the plates 40. In the closed condition, one may easily recognise the collapsed side plates. The side flaps which are capable of a folding movement in a hinge-like manner, are represented folded inwards with a closed container here. They might just as easily be designed such that they may be folded outwards and immerse into the water surface like a keel. Spoilers may be integrally formed on the edges for aiding the opening of the container when being subjected to onflow by the medium, by which means the flow may get more easily between the plates.

Briefly summarising, the device for producing electricity from a flowing medium consists of a plurality of onflow elements which are arranged essentially in a row, of which plurality a number, when immersed into the flowing medium, forms a load section, and another number of the same plurality, then running above the medium surface, forms a return section or empty section, and are led forwards and backwards via deflection elements, wherein work may be taken at least one deflection element.

The device may also be designed with a plurality of onflow elements arranged essentially in a row, said row being formed as a coherent chain, and of which plurality a number forms a load section when immersed into the flowing medium, and another number of the same plurality then running above the medium surface, forms a return section or empty section and are led forwards and backwards via deflection elements, wherein work may be taken at at least one defection element. The load section is driven in an additionally supported manner by way of the medium flow in a certain embodiment.

A method for obtaining electricity from flowing water is characterised in that, with a multitude of onflow elements arranged essentially on one another, a number of this plurality is immersed into the flowing medium and thus a load section is formed, and another number of the same plurality is held above the medium surface and thus a return section or empty section is formed, and the onflow elements are led in a revolving manner forwards and backwards over deflection elements, wherein work is taken at at least one deflection element.

The method may be suitably extended by way of the device or several of these being inserted into a channel for the influencing and the control of the medium and thus form a combined device together with the channel.

1. A device for producing electrical current from a flowing medium, with a plurality of onflow elements which are arranged essentially in a row, of which plurality, a number forms a load section when immersed into the flowing medium, and another number of the same pluralty, then running above the medium surface, forms an return section or empty section, and are led forwards and backwards via deflection elements, wherein work may be taken at at least one deflection element.

2. A device according to claim 1, characterised in that the device may be attached in the flowing water either in a floatingly anchored manner or in a non-floating, fixed manner.

3. A device according to claim 2, characterised in that the floatingly anchorable device comprises float bodies.

4. A device according to claim 2, characterised in that the firmly anchorable device comprises supports for anchoring on the bed of the flow.

5. A device according to claim, characterised in that the onflow elements are designed as containers.

6. A device according to claim 5, characterised in that the onflow elements may be guided on one side or on both sides.

7. A device according to claim 6, characterised in that the containers of the onflow elements may be impinged by a medium, and on operation, as a load section, are filled with the medium.

8. A device according to claim 6, characterised in that the medium is water.

9. A device according to claim 5, characterised in that the container consists of flexible material.

10. A device according to claim 5, characterised in that the container consists of stiff material.

11. A method for obtaining electrical current from a flowing medium, characterised in that with a plurality of onflow elements which are arranged essentially on one another, one immerses into the flowing medium with a number of this plurality and thus a load section is formed, and another number of the same plurality is kept above the medium surface and thus a return section or empty section is formed, and the onflow elements are led forwards and backwards in a revolving manner via deflection elements, wherein work is taken at at least one deflection element.

12. A method according to claim 11, characterised in that the return section is additionally driven by the flowing medium flow.

13. A device for producing electrical current from a flowing medium with a plurality of onflow elements which are arranged essentially in a row, said onflow elements being designed as a coherent chain, and, of which plurality, a number forms a load section when immersed into the flowing medium, and another number of the same plurality, then running above the medium surface, forms a return section or empty section, and are led forwards and backwards via deflection elements, wherein work may be taken at one deflection element.

14. A device according to claim 13, characterised in that the onflow elements are containers (6) which may be filled on immersion into the medium.

15. A device according to claim 13, characterised in that the containers (6) are designed such that they mutually seal in the row of the chain.

16. A device according to claim 13, characterised in that the containers are designed such that as a load section and immersed in the medium, they experience a buoyancy.

17. A device according to claim 16, characterised in that the buoyancy is effected by way of partial filling with the flowing medium or by way of float bodies (54.1).

18. A device according to claim 14, characterised in that the containers (6) comprise at least one opening in the base for decreasing the immersion buoyancy.

19. A device according to claim 13, characterised in that a channel (20) is assigned to the device (1), into which channel the device or several thereof, is or are inserted, and thus with the channel forms a combined device.

20. A device according to claim 18, characterised in that holding devices (18) are arranged on the device (1) and that the channel comprises means (19) for setting the height and inclination of the device (1) in the channel (20).

21. A device according to claim 13, characterised in that means (47, 48, 49, 50, 57) are provided, in order to drive the return section (arrow 8) in the opposite direction to the load section (arrow 9).

22. A device according to claim 21, characterised in that the empty section drive wheel (47) is designed as a water wheel which is immersed into the flow of the medium and by way of which the empty section guides (51) may be driven via the connection means (48, 49, 50).

23. Containers for one of the devices according to claim 13, characterised in that they comprises means (7), by way of which they may be joined together into a chain.

24. A container according to claim 23, characterised in that the means are hinge-like connection elements (7), by way of which the containers are designed in a pullable, pushable and rotatable manner.

25. The container according to claim 23, characterised in that the container comprises a container wall opening (58).

26. A container according to claim 23, characterised in that the container has a contour (59) influencing the flow, on the inside and outside.

27. A container according to claim 23, characterised in that the container comprises flaps with floating bodies (59.1). A container for the device according to claim 13, characterised in that it is designed in a collapsible manner.

28. A container according to claim 27, characterised in that it consists essentially of two plates (40) which are connected in a pullable, pushable and rotatable manner at one end via a connection means (7), are connected in each case at two side ends to side flaps (41), which for their part are connected via in each case a fold (44), for folding into the container or folding out of the container.
